(19) United States
(12) Patent Application Publication
(10) Pub. No.: US 2026/0235501 A1
(43) Pub. Date: Aug. 13, 2026

(54) OPTICAL CONCENTRATION MEASURING DEVICE AND OPTICAL MEMBER

(71) Applicant: Asahi Kasei Microdevices Corporation, Tokyo (JP)

(72) Inventor: Shota ISSHIKI, Tokyo (JP)

(73) Assignee: Asahi Kasei Microdevices Corporation, Tokyo (JP)

(21) Appl. No.: 19/454,718

(22) Filed: Jan. 21, 2026

(30) Foreign Application Priority Data
Feb. 7, 2025 (JP) 2025-019611
Dec. 24, 2025 (JP) 2025-281134

(51) Int. Cl. G01N 21/3504

(52) U.S. Cl. CPC G01N 21/3504; G01N 2201/08

(57) ABSTRACT

An optical concentration measuring device (1) including a substrate (2), a light emitter (3) on a main surface (20) of the substrate and emitting light, a light receiver (4), a light guide (5), and a wall portion. The light guide includes the ceiling reflective surface that is a flat surface facing the main surface and is at least a part of a ceiling portion of the housing, and a secondary reflective surface that is a quadric surface that reflects at least a portion of the light emitted by the light emitter. When the direction perpendicular to the main surface toward the ceiling reflective surface is the height direction, the maximum height of the secondary reflective surface from the main surface is a, and the minimum height of the ceiling reflective surface from the secondary reflective surface of the wall portion is b, then 0.5 ≤(b/a)≤2 is satisfied.

### CROSS-REFERENCE TO RELATED APPLICATION

The present application claims priority to and the benefit of Japanese Patent Application No. 2025-019611 filed Feb. 7, 2025, and Japanese Patent Application No. 2025-281134 filed Dec. 24, 2025, the entire contents of which are incorporated herein by reference.

### TECHNICAL FIELD

The present disclosure relates to optical concentration measuring devices and optical members.

### BACKGROUND

For example, optical concentration measuring devices that detect gas concentrations are used in various fields. An optical concentration measuring device includes, for example, a light source that emits infrared rays and a detector that detects infrared rays of a specific wavelength, in a single case. Gas to be detected is introduced into the case.

Here, in order to realize an optical concentration measuring device that is compact and has high measurement precision, a multipass cell may be used, in which a pair of mirrors are disposed opposite each other and light is reflected multiple times between the mirrors. Even at the same size, the use of a multipass cell increases the optical path length. Therefore, the effect of disturbance may be reduced, and a compact optical concentration measuring device that has high measurement precision may be realized. For example, Patent Literature (PTL) 1 describes a mold for forming a gas cell housing that causes multiple reflections inside the housing of the gas cell and eliminates the need to incorporate a mirror portion into the housing of the gas cell.

### CITATION LIST

### Patent Literature

PTL 1: JP 2022-029422 A

### SUMMARY

### Technical Problem

In an optical concentration measuring device configured to send light back and forth multiple times within an internal space of a gas cell, when a mirror is placed on a surface other than that related to a designed optical path, an optical path due to unintended reflection of light (undesigned optical path) may occur. The presence of an undesigned optical path causes performance degradation (a decrease in an average optical path length), and the measurement precision of the optical concentration measuring device decreases.

In view of the above, it would be helpful to provide an optical concentration measuring device and an optical member that can help prevent performance degradation due to an undesigned optical path.

### Solution to Problem

(1) An optical concentration measuring device according to an embodiment of the present disclosure comprises:
a substrate;
a light emitter on a main surface of the substrate and configured to emit light;
a light receiver on the main surface and configured to receive at least a portion of the light emitted by the light emitter; and a light guide that is at least a part of an inner surface of the housing provided so as to cover the main surface, the light guide being configured to guide at least a portion of the light emitted by the light emitter to the light receiver, wherein
the light guide includes a ceiling reflective surface that is a flat surface facing the main surface and is at least a part of a ceiling portion of the housing, a secondary reflective surface that is a quadric surface configured to reflect at least a portion of the light emitted by the light emitter, and a wall portion that connects the secondary reflective surface and the ceiling reflective surface, and
when a direction perpendicular to the main surface toward the ceiling reflective surface is a height direction, a maximum height of the secondary reflective surface from the main surface is a, and a minimum height of the ceiling reflective surface from the secondary reflective surface of the wall portion is b, then 0.5≤(b/a)≤2 is satisfied.
(2) As an embodiment of the present disclosure, (1), wherein,
in a cross-section of the secondary reflective surface, the wall portion, and the ceiling reflective surface taken so as to include the light reflected by the secondary reflective surface, a connection angle between the secondary reflective surface and the wall portion is 60° or more and 135° or less, and a connection angle between the wall portion and the ceiling reflective surface is 60° or more and 135° or less, and
the cross-section is a plane perpendicular to the main surface and parallel to one edge of the main surface.
(3) As an embodiment of the present disclosure (2), wherein
the connection angle between the secondary reflective surface and the wall portion is 60° or more and 120° or less, and the connection angle between the wall portion and the ceiling reflective surface is 60° or more and 120° or less.
(4) As an embodiment of the present disclosure, any one of (1) to (3), wherein
the light guide is a component integrated with the housing.
(5) As an embodiment of the present disclosure, any one of (1) to (4), wherein
a wavelength of the light is 2 μm to 10 μm.
(6) As an embodiment of the present disclosure, any one of (1) to (5), wherein,
in a cross-section of the secondary reflective surface, the wall portion, and the ceiling reflective surface taken so as to include the light reflected by the secondary reflective surface, the ceiling reflective surface is positioned in a range that can be reached by the light emitted from the light emitter at an emission angle of up to 60°.
(7) As an embodiment of the present disclosure, any one of (1) to (6), wherein
the light emitter is configured to emit more than 20 % of a total amount of the light at an emission angle greater than 45°.
(8) As an embodiment of the present disclosure, any one of (1) to (7), wherein
the wall portion is a flat surface, a curved surface, a combination of a flat surface and a curved surface, or a surface having periodicity.
(9) As an embodiment of the present disclosure, any one of (1) to (8), wherein
the light emitter is a surface light source that emits the light from a light-emitting surface.
(10) An optical member according to an embodiment of the present disclosure is
an optical member used in an optical concentration measuring device comprising: a substrate; a light emitter on a main surface of the substrate and configured to emit light; a light receiver on the main surface and configured to receive at least a portion of the light emitted by the light emitter; and a light guide that is at least a part of an inner surface of a housing provided so as to cover the main surface, the light guide being configured to guide at least a portion of the light emitted by the light emitter to the light receiver, the optical member comprising: the light guide;
a ceiling reflective surface that is a flat surface facing the main surface and is at least a part of a ceiling portion of the housing; a secondary reflective surface that is a quadric surface configured to reflect at least a portion of the light emitted by the light emitter; and a wall portion that connects the secondary reflective surface and the ceiling reflective surface, wherein,
when a direction perpendicular to the main surface toward the ceiling reflective surface is a height direction, a maximum height of the secondary reflective surface from the main surface is a, and a minimum height of the ceiling reflective surface from the secondary reflective surface of the wall portion is b, then 0.5≤(b/a)≤2 is satisfied.

### Advantageous Effect

According to an embodiment of the present disclosure, it is possible to provide an optical concentration measuring device and an optical member that can help prevent performance degradation due to an undesigned optical path.

### BRIEF DESCRIPTION OF THE DRAWINGS

In the accompanying drawings:

FIG. 1 is a partially transparent perspective diagram of an optical concentration measuring device according to an embodiment of the present disclosure;

FIG. 2 is a diagram for explaining a light guide on an inner surface of a housing;

FIG. 3 is a diagram for explaining a height of a secondary reflective surface and a wall portion;

FIG. 4 is a cross-section diagram of the secondary reflective surface, the wall portion, and a ceiling reflective surface taken along a line including light reflected by the secondary reflective surface; and

FIG. 5 is a diagram illustrating a configuration of a secondary reflective surface of a comparative example.

### DETAILED DESCRIPTION

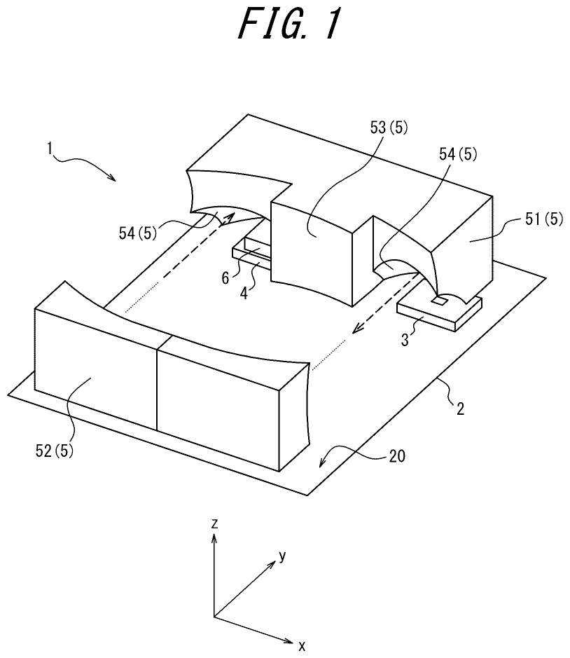

FIG. 1 is a partially transparent perspective diagram of an optical concentration measuring device 1 according to an embodiment of the present disclosure. The optical concentration measuring device 1 is a compact device, 20 mm×10 mm×10 mm as an example, and is also referred to as a gas sensor. According to the present embodiment, the optical concentration measuring device 1 is a non-dispersive infrared (NDIR) type device that measures the concentration of a gas to be detected based on infrared radiation transmitted through the gas that is introduced. The gas to be detected may be, for example, carbon dioxide, water vapor, methane, propane, formaldehyde, carbon monoxide, nitrogen monoxide, ammonia, sulfur dioxide, alcohol, or the like, or a mixture of any of these gases.

Here, the wavelength of the light (infrared light according to the present embodiment) may be 2 μm to 10 μm. The range of 2 μm to 10 μm contains many absorption bands specific to various gases, making it a wavelength range particularly suitable for use in gas sensors. For example, there is an absorption band for methane at a wavelength of 3.3 μm, for carbon dioxide at a wavelength of 4.3 μm, and for alcohol (ethanol) at a wavelength of 9.5 μm.

The configuration of the optical concentration measuring device 1 according to the present embodiment allows use as a light emitting and receiving device for applications other than gas detection. That is, disclosure content derived by replacing “optical concentration measuring device 1” as described above with “concentration measuring device”, “optical physical quantity measuring device”, “light receiving and emitting device”, “optical device”, or the like is included in the scope of the present disclosure. For example, the state of an optical path space can be detected (examples other than gas include the presence or absence or concentration of a specific component of a fluid). For example, the disclosure content can be used for a component detection device or a component concentration measuring device for a substance (for example, water or a body fluid) present in an optical path space between the light emitter and the light receiver. For example, when the substance present in the optical path space is blood, the component detection device or the component concentration measuring device can be used to measure glucose concentration in blood.

The component detection device or the component concentration measuring device can measure glucose concentration in blood by measuring absorption of light having a wavelength of 1 μm to 10 μm. In the measurement of glucose concentration in blood, measuring absorption of light in a 1.6 μm band, a 2.0 μm band, and a 10.0 μm band is preferred. A compact, high precision, and highly reliable non-invasive glucose concentration meter can be realized. Such a glucose concentration meter allows, for example, a diabetic patient to self-check blood sugar levels with good precision and without causing damage to the skin as would occur with an invasive method. Further, more accurate administration of medication (for example, insulin) can be achieved, based on the blood sugar levels checked.

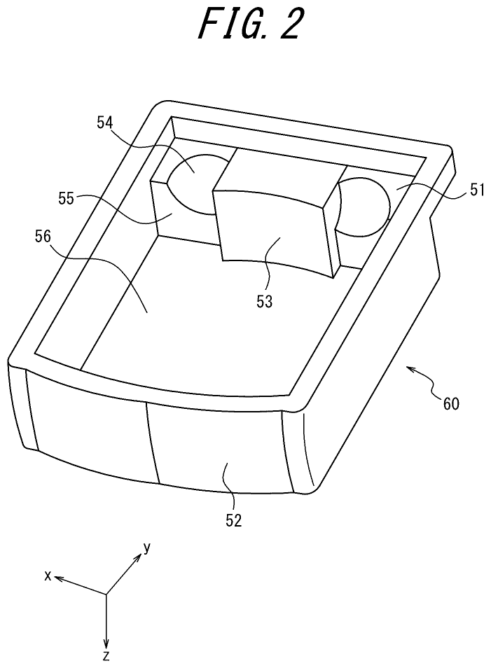

The optical concentration measuring device 1 includes a substrate 2, a light emitter 3, a light receiver 4, and a light guide 5. As per the present embodiment, the optical concentration measuring device 1 may further include an optical filter 6. FIG. 1 illustrates an example configuration of the optical concentration measuring device 1 with a portion of the light guide 5 made transparent, and the light emitter 3, the light receiver 4, and the optical filter 6 on a main surface 20 of the substrate 2 visible. According to the present embodiment, the main surface 20 is the surface with the largest area of the substrate 2 on which the light guide 5 is disposed. According to the present embodiment, the light guide 5 is at least a part of a housing 60 (see FIG. 2) provided to cover the main surface 20.

Hereinafter, as illustrated in FIG. 1, a Cartesian coordinate system is set so that the xy-plane is parallel to the main surface 20 of the substrate 2. The Cartesian coordinate system is used throughout FIG. 2 to FIG. 5. The z-axis direction is perpendicular to the main surface 20 of the substrate 2. The z-axis direction may also be referred to as the height direction. The x-axis direction and the y-axis direction are parallel to edges of the main surface 20 of the substrate 2. Hereinafter, the view of the front of the main surface 20 of the substrate 2 may also be referred to as the overhead view. The viewing direction in the case of the overhead view corresponds to the negative z-axis direction.

The substrate 2 is a board-like member that mounts components of the optical concentration measuring device 1 and makes electrical connections for mounted electronic components. According to the present embodiment, the substrate 2 is a printed circuit board (PCB). The material of the substrate 2 may be, for example, paper, glass cloth, ceramic, polyimide, liquid crystal polymer, or the like. The substrate 2 has the light emitter 3, the light receiver 4, and the light guide 5 mounted on the main surface 20. The substrate 2 may also have the optical filter 6 mounted on the main surface 20. The substrate 2 may further mount other electronic components. For example, the substrate 2 may be provided with a controller that controls at least one of the light emitter 3 or the light receiver 4 on the main surface 20 or on a bottom surface that is the opposite side to the main surface 20. Further, the substrate 2 may be provided with an arithmetic unit on the main surface 20 or on the bottom surface to execute arithmetic operations in gas concentration calculation. The arithmetic unit may include at least one general-purpose processor that executes functions according to a program to be read and may include at least one dedicated processor specialized for a particular process. The dedicated processor may include an application specific integrated circuit (ASIC). The arithmetic unit may be integrated with the controller described above.

The light emitter 3 is a component that emits light used to detect the gas to be detected. The light emitter 3 is not particularly limited as long as the light emitter 3 outputs light including a wavelength that is absorbed by the gas to be detected. According to the present embodiment, the light emitted by the light emitter 3 is infrared light, but is not limited to this example. According to the present embodiment, the light emitter 3 is a light emitting diode (LED), and emits light from a light-emitting surface. The light-emitting surface is a surface of the light emitter 3 that is in contact with the gas and is made of an optically transparent material. According to the present embodiment, the light emitter 3 is a surface light source that emits light from a light-emitting surface, but is not limited to being a surface light source. As other examples, the light emitter 3 may be an organic light-emitting element, a lamp, a micro-electromechanical systems (MEMS) heater, or the like. The light emitter 3 is disposed on the main surface 20 of the substrate 2, opposite one of the secondary reflective surfaces 54, described below.

The light receiver 4 is a component that receives light transmitted through the gas that is introduced. The light receiver 4 receives at least a portion of the light emitted by the light emitter 3. The light receiver 4 is not particularly limited as long as the light receiver 4 is sensitive to a band of light that includes a wavelength absorbed by the gas to be detected. According to the present embodiment, light received by the light receiver 4 is infrared light, but is not limited to this example. According to the present embodiment, the light receiver 4 is a photodiode that receives light at a light-receiving surface. Here, the light-receiving surface is a surface of the light receiver 4 that is in contact with the gas and is made of an optically transparent material. As other examples, the light receiver 4 may be a phototransistor or thermopile, a pyroelectric sensor, a bolometer, or the like. The light receiver 4 converts received light into an electrical signal and outputs the converted electrical signal. The electrical signal is output to, for example, an arithmetic unit. Upon receiving the electrical signal, the arithmetic unit calculates the concentration of the gas to be detected, based on light transmittance and the like. The light receiver 4 is disposed on the main surface 20 of the substrate 2, opposite the other one of the secondary reflective surfaces 54, described below.

According to the present embodiment, the light receiver 4 includes the optical filter 6 that has a wavelength selection function. The optical filter 6 transmits light emitted from the light emitter 3 and reflected by the light guide 5 to reach the light-receiving surface of the light receiver 4. Here, the optical filter 6 need only be provided on the optical path and need not be included in the light receiver 4. Further, the optical concentration measuring device 1 may be configured without the optical filter 6.

The light guide 5 is a member that guides at least a portion of the light emitted by the light emitter 3 to the light receiver 4. The light guide 5 is an optical system of the optical concentration measuring device 1. The light guide 5 includes optical members and configures the optical path from the light emitter 3 to the light receiver 4. In other words, the light guide 5 optically connects the light emitter 3 and the light receiver 4. Here, an optical member is, for example, a mirror. The optical members may also include a lens or the like.

According to the present embodiment, the light guide 5 includes a first reflector 51 and a second reflector 52. As illustrated in FIG. 1, the first reflector 51 and the second reflector 52 are connected to the main surface 20 of the substrate 2 and are opposite each other in the overhead view. Further, the first reflector 51 and the second reflector 52 may be held in a structure that has a function of holding the relative positions of the first reflector 51 and the second reflector 52, and the structure may be in the form of a connection to the main surface 20 of the substrate 2. According to the present embodiment, the housing 60 (see FIG. 2) is used as the structure that holds the relative positions of the first reflector 51 and the second reflector 52.

The first reflector 51 is configured to include a main reflective surface 53 that is a quadric surface, and two secondary reflective surfaces 54 that are each quadric surfaces. Here, quadric surfaces may include, for example, parabolic, ellipsoidal, spherical surfaces, and the like, and may have rotational axis symmetry. The second reflector 52 is configured to have two quadric surfaces. For example, the second reflector 52 may be configured to have two spherical surfaces joined together at a reflective surface opposite the first reflector 51. The first reflector 51 has three functions. The first function is to reflect light emitted from the light emitter 3 in the z-axis direction in the xy plane direction perpendicular to the z-axis direction. Here, the xy plane direction is a direction having a component in at least one of the x-axis direction and the y-axis direction. However, the xy plane direction may include a z-axis direction component. The second function is to cause multiple reflections of light with the second reflector 52. The third function is to reflect the multiple-reflected light to the light receiver 4.

One of the secondary reflective surfaces 54 near the light emitter 3 reflects at least a portion of the light emitted from the light emitter 3. The light reflected by the one of the secondary reflective surfaces 54 is reflected by the second reflector 52 and the main reflective surface 53 to traverse back and forth between the second reflector 52 and the main reflective surface 53 multiple times. The optical path is configured to traverse through a cell (internal space) between the light guide 5 and the substrate 2, where gas is introduced. The other one of the secondary reflective surfaces 54 near the light receiver 4 reflects light from the second reflector 52 and guides the light to the light receiver 4. Here, the light guide 5 may be configured to include a lens in a portion of the optical path. The one of the secondary reflective surfaces 54 near the light emitter 3 and the other one of the secondary reflective surfaces 54 near the light receiver 4 are both quadric surfaces, but need not be the same curved surface.

Material of the main reflective surface 53 and the secondary reflective surfaces 54 of the first reflector 51 and the reflective surface of the second reflector 52 may be, but is not limited to, metal, glass, ceramic, stainless steel, and the like. From the viewpoint of improving detection sensitivity, the material of these mirrors is preferably a material that has a low light absorption coefficient and high reflectance. Specifically, a resin housing coated with an alloy containing aluminum, gold, or silver, a dielectric, or a laminate thereof is preferred. From the viewpoint of reliability and aging, a resin housing coated with gold or an alloy layer containing gold is preferred. Vapor deposition or coating applied to a resin housing may provide improved productivity and lighter weight compared to forming with a metal material. Further, a difference in thermal expansion coefficient from the substrate 2 is reduced, thermal deformation is suppressed, and sensitivity fluctuation is suppressed.

FIG. 2 illustrates the housing 60 made of resin having an inner surface coated with the alloy layer described above. The housing 60 is provided so as to cover the main surface 20 of the substrate 2, and constitutes a cell (internal space) into which a gas is introduced. As illustrated in FIG. 2, the inner surface of the housing 60, which is the surface in contact with the internal space, is formed with the light guide 5 including the main reflective surface 53 and the secondary reflective surfaces 54 of the first reflector 51 and the second reflector 52. That is, according to the present embodiment, the light guide 5 is a component integrated with the housing 60. By integrating the light guide 5 with the housing 60, it is possible to omit a process of adjusting tolerances that would be required when incorporating a mirror of the light guide 5 as a separate component, thereby achieving high robustness.

As illustrated in FIG. 2, the light guide 5 further includes a ceiling reflective surface 56 that is a flat surface facing the main surface 20 and that is at least a part of the ceiling portion of the housing 60. The housing 60 is an integrated component including the light guide 5, and therefore when the alloy layer is coated on the reflective surfaces of the first reflector 51 and the second reflector 52, the ceiling reflective surface 56 is also coated with the alloy layer at the same time. In this way, the ceiling reflective surface 56, like the main reflective surface 53 and secondary reflective surfaces 54 of the first reflector 51 and the reflective surface of the second reflector 52, is made of a material having a low light absorption coefficient and high reflectance, and reflects light. Although not illustrated in FIG. 2, a portion of the ceiling reflective surface 56 may be provided with a ventilation portion for introducing the gas to be detected into the cell (internal space).

Further, as illustrated in FIG. 2, the housing 60 also includes a wall portion 55 that connects the secondary reflective surfaces 54 and the ceiling reflective surface 56. In other words, the portion of the housing 60 that connects the secondary reflective surfaces 54 and the ceiling reflective surface 56 is called the wall portion 55. The light guide 5 may include the wall portion 55. The wall portion 55 may be a flat surface, a curved surface, a combination of a flat surface and a curved surface, or a surface having periodicity.

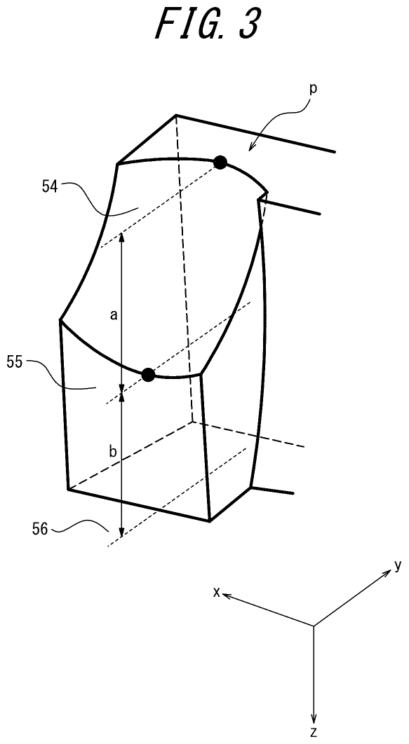

FIG. 3 is a diagram for explaining the height of the secondary reflective surface 54 and the wall portion 55, and corresponds to an enlarged view of a portion including the secondary reflective surface 54, the wall portion 55, and the ceiling reflective surface 56 in FIG. 2. However, for ease of viewing, an example is illustrated in which the main reflective surface 53 is placed in a direction distanced from the secondary reflective surface 54 and the wall portion 55, that is, distanced from the second reflector 52 in the positive y-axis direction. In FIG. 3, p indicates a surface that comes into contact with the main surface 20 of the substrate 2 when the housing 60 is disposed so as to cover the main surface 20. Further, p indicates the surface that comes into contact with adhesive or the like when the housing 60 is fixed to the main surface 20 of the substrate 2 with adhesive or the like. That is, p indicates a position in the height direction of the main surface 20. As illustrated in FIG. 3, the direction perpendicular to the main surface 20 toward the ceiling reflective surface 56 (z-axis direction) is the height direction, and the maximum height of the secondary reflective surface 54 from the main surface 20 is a, and the minimum height of the ceiling reflective surface 56 from the secondary reflective surface 54 of the wall portion 55 is b. In the optical concentration measuring device 1 according to the present embodiment, 0.5≤(b/a)2 is satisfied.

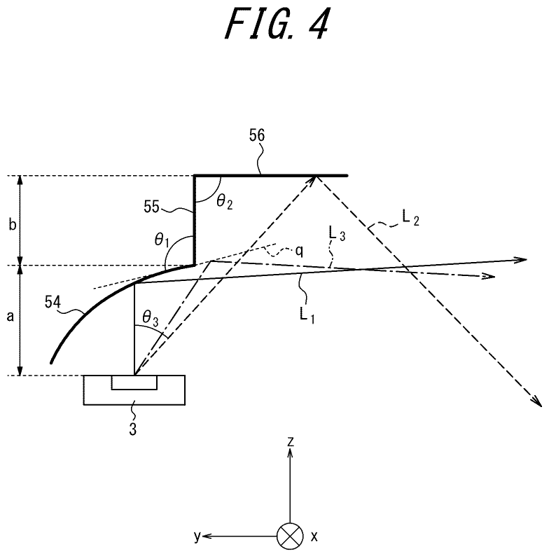

FIG. 4 illustrates a cross-section of the secondary reflective surface 54, the wall portion 55, and the ceiling reflective surface 56 taken along a plane parallel to the yz plane so as to include light reflected by the secondary reflective surface 54 in the xy plane direction. In the example of FIG. 4, the light emitted by the light emitter 3 is reflected by the secondary reflective surface 54 in the xy plane direction. In FIG. 4, L₁ indicates such a designed optical path. Here, for example, the light emitter 3 emits more than 20 % and less than 60 % of a total amount of light at an emission angle greater than 45°, and emits 40% or more and 80 % or less of the total amount of light at an emission angle of 0° or more and 45° or less. In FIG. 4, the emission angle is indicated as θ₃. However, most of the light emitted from the light emitter 3 at an emission angle up to 60° greatly affects the performance of the optical concentration measuring device 1, such as the average optical path length. The presence of the wall portion 55 makes the secondary reflective surface 54 and the ceiling reflective surface 56 have very different reflective surface shapes. Light that reaches the ceiling reflective surface 56 from the light emitter 3 is reflected toward the main surface 20 of the substrate 2 as indicated by L₂ in FIG. 4. That is, light reflected other than by the first reflector 51 and the second reflector 52 is separated from the designed optical path. Therefore, there is no undesigned optical path in which light emitted from a light source travels along an undesigned optical path and is guided to the light receiver, so it is possible that performance degradation does not occur and high measurement precision is achieved.

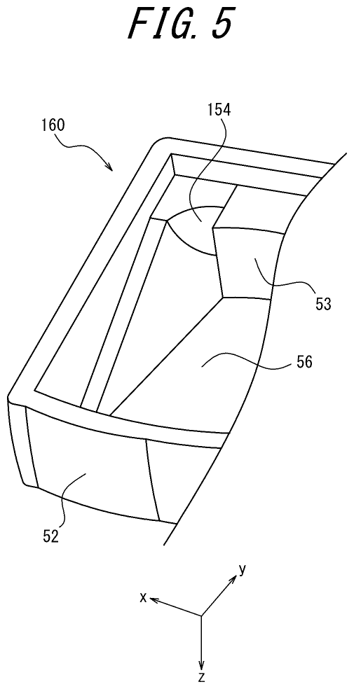

FIG. 5 illustrates a configuration of a secondary reflective surface 154 of a comparative example. In a housing 160 of the comparative example, the secondary reflective surface 154 extends smoothly to the ceiling reflective surface 56, and the wall portion 55 does not exist. Therefore, a reflective surface such as q indicated in FIG. 4 is generated. The reflective surface q is a surface that extends smoothly from the secondary reflective surface 54, and therefore the surface shape does not change significantly from the secondary reflective surface 54. As a result, an undesigned optical path occurs due to unintended reflection of light, as indicated by L₃ in FIG. 4. An example of an undesigned optical path here is an optical path in which light emitted from the light emitter 3 is reflected by the secondary reflective surface 154, then reflected by the second reflector 52, and while in the original designed optical path it would then be reflected by the main reflective surface 53 of the first reflector 51, but is instead reflected by the other secondary reflective surface of the secondary reflective surfaces 154 of the first reflector and guided to the light receiver. The occurrence of an undesigned optical path having a short optical path length causes performance degradation (a decrease in the average optical path length), resulting in a decrease in measurement precision.

When light is reflected by the ceiling reflective surface 56, the presence of the wall portion 55 can prevent the occurrence of an undesigned optical path. When the light distribution of the light emitter 3 is a Lambertian distribution, approximately 75 % of light emitted from the light emitter 3 is emitted at an angle of 0° to 60°. Therefore, when the wall portion 55 is provided and the ceiling reflective surface 56 is positioned in a range that can accommodate light emitted from the light emitter 3 at an emission angle of up to 60°, it is possible to almost completely eliminate light that passes through an undesigned optical path.

In the optical concentration measuring device 1 according to the present embodiment, the housing 60 includes the wall portion 55 that steeply connects the secondary reflective surfaces 54 and the ceiling reflective surface 56, thereby suppressing the occurrence of undesigned optical paths. Here, according to the present embodiment, a connection angle (θ₁) between the secondary reflective surface 54 and the wall portion 55 is designed to be 60°or more and 135°or less, and a connection angle (θ₂) between the wall portion 55 and the ceiling reflective surface 56 is designed to be 60° or more and 135° or less. Each connection angle may be determined from the tangents of the secondary reflective surface 54 and the wall portion 55 at a connection point between the secondary reflective surface 54 and the wall portion 55, and the tangents of the wall portion 55 and the ceiling reflective surface 56 at a connection point between the wall portion 55 and the ceiling reflective surface 56, in a cross-section taken along a plane perpendicular to the main surface 20 and parallel to the yz plane. Here, there are multiple cross-sections along a plane parallel to the yz plane, and therefore the above condition may be satisfied by any of the cross-sections taken along a plane parallel to the yz plane, as required. Further, the connection angle (θ₁) between the secondary reflective surface 54 and the wall portion 55 and the connection angle (θ₂) between the wall portion 55 and the ceiling reflective surface 56 are preferably 60° or more and 135° or less from the viewpoint of greatly changing reflective surface shapes, but even when 60° or more and 120° or less, the occurrence of undesigned optical paths can be sufficiently suppressed.

For verification purposes, simulations were carried out on the light guide 5 formed on the inner surface of the housing 60 as illustrated in FIG. 2 and the light guide 5 formed on the inner surface of the housing 160 as illustrated in FIG. 5, and average optical path lengths were calculated. When the light guide 5 of FIG. 2 was used, no undesigned optical path occurred, and good results were obtained. On the other hand, when the light guide 5 of FIG. 5 was used, the number of multiple reflections was small, so an undesigned optical path that was about ¼ the length of the designed optical path occurred at a rate of several percent, and the average optical path length decreased.

As described above, the optical concentration measuring device 1 and the optical member according to the present embodiments can help prevent performance degradation due to undesigned optical paths by virtue of the above-described configurations.

Although embodiments have been described based on the drawings and examples, it should be noted that a person skilled in the art may easily make variations and modifications based on the present disclosure. Therefore, it should be noted that such variations and modifications are included within the scope of the present disclosure.

1. An optical concentration measuring device comprising:
a substrate;
a light emitter on a main surface of the substrate and configured to emit light;
a light receiver on the main surface and configured to receive at least a portion of the light emitted by the light emitter; and
a light guide that is at least a part of an inner surface of the housing provided so as to cover the main surface, the light guide being configured to guide at least a portion of the light emitted by the light emitter to the light receiver, wherein
the light guide includes a ceiling reflective surface that is a flat surface facing the main surface and is at least a part of a ceiling portion of the housing, a secondary reflective surface that is a quadric surface configured to reflect at least a portion of the light emitted by the light emitter, and a wall portion that connects the secondary reflective surface and the ceiling reflective surface, and
when a direction perpendicular to the main surface toward the ceiling reflective surface is a height direction, a maximum height of the secondary reflective surface from the main surface is a, and a minimum height of the ceiling reflective surface from the secondary reflective surface of the wall portion is b, then 0.5≤(b/a)≤2 is satisfied.

2. The optical concentration measuring device according to claim 1, wherein, in a cross-section of the secondary reflective surface, the wall portion, and the ceiling reflective surface taken so as to include the light reflected by the secondary reflective surface, a connection angle between the secondary reflective surface and the wall portion is 60° or more and 135° or less, and a connection angle between the wall portion and the ceiling reflective surface is 60° or more and 135° or less, and
the cross-section is a plane perpendicular to the main surface and parallel to one edge of the main surface.

3. The optical concentration measuring device according to claim 2, wherein the connection angle between the secondary reflective surface and the wall portion is 60° or more and 120° or less, and the connection angle between the wall portion and the ceiling reflective surface is 60° or more and 120° or less.

4. The optical concentration measuring device according to claim 1, wherein the light guide is a component integrated with the housing.

5. The optical concentration measuring device according to claim 1, wherein a wavelength of the light is 2 μm to 10 μm.

6. The optical concentration measuring device according to claim 1, wherein, in a cross-section of the secondary reflective surface, the wall portion, and the ceiling reflective surface taken so as to include the light reflected by the secondary reflective surface, the ceiling reflective surface is positioned in a range that can be reached by the light emitted from the light emitter at an emission angle of up to 60°.

7. The optical concentration measuring device according to claim 1, wherein the light emitter is configured to emit more than 20 % of a total amount of the light at an emission angle greater than 45°.

8. The optical concentration measuring device according to claim 1, wherein the wall portion is a flat surface, a curved surface, a combination of a flat surface and a curved surface, or a surface having periodicity.

9. The optical concentration measuring device according to claim 1, wherein the light emitter is a surface light source that emits the light from a light-emitting surface.

10. An optical member used in an optical concentration measuring device comprising: a substrate; a light emitter on a main surface of the substrate and configured to emit light; a light receiver on the main surface and configured to receive at least a portion of the light emitted by the light emitter; and a light guide that is at least a part of an inner surface of a housing provided so as to cover the main surface, the light guide being configured to guide at least a portion of the light emitted by the light emitter to the light receiver, the optical member comprising: the light guide;
a ceiling reflective surface that is a flat surface facing the main surface and is at least a part of a ceiling portion of the housing; a secondary reflective surface that is a quadric surface configured to reflect at least a portion of the light emitted by the light emitter; and a wall portion that connects the secondary reflective surface and the ceiling reflective surface, wherein,
when a direction perpendicular to the main surface toward the ceiling reflective surface is a height direction, a maximum height of the secondary reflective surface from the main surface is a, and a minimum height of the ceiling reflective surface from the secondary reflective surface of the wall portion is b, then 0.5≤(b/a)≤2 is satisfied.
